(19) United States
(12) Patent Application Publication
(10) Pub. No.: US 2006/0271966 A1
(43) Pub. Date: Nov. 30, 2006

(54) Apparatus for, and method of, receiving satellite television signals in an apartment building and providing television images in the receivers in such building

(76) Inventors: Frederik Nanoo Staal, Brea, CA (US); Robert Allen Hawley, Tustin, CA (US); Kelly B. Cameron, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/284,098

(22) Filed: Nov. 21, 2005

Related U.S. Application Data
(63) Continuation of application No. 09/808,373, filed on Mar. 13, 2001, now abandoned.
Application No. 09/808,373 is a continuation of application No. 09/056,535, filed on Apr. 8, 1998, now abandoned.

(51) Int. Cl. H04N 7/20; H04N 7/18

(52) U.S. Cl. 725/68; 725/63; 725/78; 725/80

(57) ABSTRACT

Digital packets, defined by a sync byte and then 130 MPEG2 compressed QPSK signal bytes, from a satellite transponder are reformatted prior to transmission to television receivers in apartments in a building wired to distribute video signals. A side byte between such sync and signal bytes in each packet indicates (a) any QPSK packet uncorrectable error and (b) processing information which allows automatic reconfiguration at the settop box. Additional FEC bytes correct to 8 errors within a MPEG2_{QPSK} packet. The system removes the FEC bytes and reframes the MPEG2_{QPSK} packets into a superpacket by converting a first number of the MPEG2_{QPSK} packets to a second number of MPEG2_{QAM} packets. An added sync byte indicates the beginning of each such MPEG2_{QAM} packet. The system adds side data bytes including any uncorrectable errors in each MPEG2_{QPSK} packet and adds a new, less complicated FEC to each MPEG2_{QAM} packet. The system modulates and upconverts the bytes in each MPEG2_{QAM} packet and passes them through a cable plant constructed to receive modulated QAM bytes (or NTSC signals) which are demodulated at the settop box. The additional FEC bytes correct to 8 errors within a MPEG2_{QAM} packet and are then removed. The superpacket is deframed to obtain the MPEG2_{QPSK} packets. After finding a television channel, the side bytes are processed to determine the frequency location of the other channels in the apartment receivers and the existence of uncorrectable errors. The MPEG2_{QAM} bytes are decompressed and encoded to reproduce the television images in the apartment receivers.

This invention relates to systems for, and methods of, introducing digital QPSK television signals from satellite transponders into television receivers in apartment buildings which are wired to distribute analog NTSC or digital QAM television signals transmitted from a cable head end system with lower frequency carriers than the satellite signals. More particularly, the invention relates to a repacketizer system for, and method of, converting a first number of MPEG2 signal bytes from a QPSK satellite receiver (referred to as MPEG2_{QPSK}) into a second number of MPEG2 signal bytes ready for transmission in a cable plant using QAM (referred to as MPEG2_{QAM}) by defining superpackets formed from a first plurality of MPEG2_{QPSK} packets or a second plurality (preferably different from the first plurality) of MPEG2_{QAM} packets. The invention also covers the inclusion of an uncorrectable error flag and side data into the superpacket.

### BACKGROUND OF THE INVENTION

Television signals can be transmitted using either traditional analog or, more recently, digital technologies. Either type of signal can be transmitted through the atmosphere (using terrestrial or satellite transmitters), provided via coaxial cables or using some combination of these techniques.

Analog approaches use NTSC signals in the United States. NTSC signals transmitted terrestrially through the atmosphere usually consist of approximately 25 channels, are called “off-air” signals, and can be received by any standard television using “rabbit ears” or a rooftop antenna. NTSC signals transmitted via cable can have noticeabily higher quality and often support more channels, approximately 50 to 60 in 350 MHz. Each of these individual signals takes the same amount of bandwidth as the “off-air” signals. In most cases, these cable signals are created in a cable head end system which initially receives NTSC signals transmitted through the atmosphere terrestrially or from a satellite, and then redistributes them via cable to the end user.

Digital approaches guarantee consistent quality over a broader range of impairments from noise or interference than NTSC “off-air” signals. This performance is implemented by taking advantage of inherent noise margins of digital signals and by using digital error correction techniques. In addition, compression techniques, like MPEG2, give these approaches better bandwidth utilization, resulting in significantly more channels, often supporting 150 to 200 channels in 200 MHz.

When digital signals are transmitted from a satellite, they need very strong error correction codes and, even then, can only use lower order modulation schemes due to the noisy atmosphere. In most cases, a QPSK modulation scheme is used along with a concatenated convolutional encoder and a Reed Solomon forward error correction code. Using this approach with MPEG2 compressed data, referred to as MPEG2_{QPSK}, requires 1000 MHz of bandwidth to transmit 32 Transponders, supporting 175 channels. Transmission of these signals often uses only 500 MHz of bandwidth from the 90 to 1450 MHz frequency band by using two orthogonal carriers. An equivalent number of NTSC signals would require the full 1000 MHz of bandwidth.

When digital signals are transmitted via cable, they can use simpler error correction codes and higher order QAM modulation schemes due to the elatively clean cable environment. They also use MPEG2 compressed data which we will refer to as MPEG2_{QAM}. Using this technique to provide the same 175 channels mentioned previously would only require 200 MHz of bandwidth.

In comparing the available services, it is clear that the digital services are, in most instances, superior to the analog services. In addition, the satellite and cable systems are, in most instances, superior to the off air NTSC services. Although the best services are digital satellite and digital cable, there are some key differences between these services. The key drawback of cable systems is that most of the cable companies have not yet transitioned to digital transmission techniques. The satellite providers offer users the capability to “go digital” without waiting for their local cable company. A second drawback of cable systems is that they do not provide service to remote areas within the United States, while the satellite signals are available anywhere within the continental United States.

The cable systems do provide local state, county, and even city specific programs which are often not available with the satellite systems. The satellite systems offer local programs from some of the big cities like New York or Los Angeles, but otherwise do not have the same capability. On the other hand, some of the satellite television suppliers offer exclusive sports coverage which is not available elsewhere.

The digital systems, both satellite and cable, are creating new markets for bidirectional communications and are beginning to offer Internet access, home shopping and video on demand, using a telco return for upstream access. Cable systems have the advantage of a higher bandwidth return using the cable for both downstream and upstream communications. This will allow them to offer services like cable modem, telephone over cable, and video conferencing.

Though programming and services will change significantly as cable companies transition to digital services and gain better bandwidth utilization, currently many individuals and families are electing to purchase digital satellite television services to take advantage of the benefits of digital technology and to enjoy the available programs.

Although digital satellite signals, using QPSK, are readily available anywhere in the United States, they are not optimal for individuals and families living in apartments in an apartment building for two key reasons. First, apartment buildings are wired with cables capable of distributing only 500 to 800 MHz of bandwidth with up to a 800 MHz carrier. This provides sufficient bandwidth for QAM channels, but neither the bandwidth nor the capability to handle the higher bandwidth carriers of the QPSK signals. The second reason is that individuals and families living in apartment buildings may not have access to the rooftop to place a receiving antenna, may not have line of sight access to the satellite, or may not be allowed to place an antenna outside of the apartment building due to rules and regulations in the apartment building.

The solution to provide individuals and families living in apartment buildings access to these satellite systems is to convert from digital satellite signals using QPSK to digital cable signals using QAM. This conversion is fairly complex due to the different types of modulation, the different types of FEC, and even different implementations of MPEG2 compression, resulting in different transport streams. DIRECRTV satellite signals use a 130 byte transport stream which we have referred to as MPEG2_{QPSK}, while the cable systems generally use a 187 byte transport stream which we have referred to as MPEG2_{QAM}. For the purposes of this patent application, the content of the MPEG2 transport streams are not important and consequently the only difference between the MPEG2_{QPSK} and MPEG2_{QAM} transport streams that need to be discussed is the difference in length.

### BRIEF DESCRIPTION OF THE INVENTION

This invention provides a system for, and a method of, receiving a 130 byte MPEG2_{QPSK} transport stream from a satellite QPSK receiver and for reframing or repacketizing such signal bytes to a 187 byte MPEG2_{QAM} transport stream to be supplied to a head-end cable plant QAM transmitter. In providing this reframing, the system reframes packets of 130 byte MPEG2_{QPSK} signals to packets of 187 byte MPEG2_{QAM} signals by providing a number of MPEG2_{QPSK} packets in a superpacket and by organizing the signal bytes in the MPEG2_{QPSK} packets in the superpacket to mimic the signal bytes in MPEG2_{QAM} packets.

In one embodiment of the invention, digital packets, defined by a sync byte and then 130 MPEG2 compressed QPSK signal bytes, from a satellite transponder to television receivers are reformatted prior to transmission in apartments in a building wired to distribute video signals. A side byte between such sync and signal bytes in each packet indicates (a) any QPSK packet uncorrectable error and (b) processing information which allows automatic reconfiguration at the settop box. Each packet includes additional bytes for forward error correction (FEC).

Additional FEC bytes correct to 8 errors within a MPEG2_{QPSK} packet. The system removes the FEC bytes and reframes the MPEG2_{QPSK} packets into a superpacket by converting a first number of the MPEG2_{QPSK} signal bytes to a second number of MPEG2_{QAM} signal bytes. An added sync byte indicates the beginning of each such MPEG2_{QAM} packet. The system adds side data bytes including any uncorrectable errors in each MPEG2_{QPSK} packet and adds a new, less complicated FEC to each MPEG2_{QAM} packet in the superpacket.

The system modulates and upconverts the signal bytes in each MPEG2_{QAM} packet and passes them through a cable plant constructed to receive modulated QAM bytes (or NTSC signals) which are demodulated at the settop box. The additional FEC bytes correct to 8 errors within a MPEG2_{QAM} packet and are then removed. The superpacket is deframed to obtain the original MPEG2_{QAM} packets. After finding a first television channel, the side bytes are processed to determine the frequency location of the other channels in the apartment receivers and any existence of uncorrectable errors. The MPEG2_{QAM} bytes are decompressed and encoded to reproduce the television images in the apartment receivers.

The invention consists of a reframer or repacketizer to convert MPEG2 formats, an uncorrectable error flag to invoke MPEG error concealment algorithms downstream in the settop box, and side data to speed up initial acquisition/setup of the settop box and to allow automatic reconfiguration whenever the frequency mappings are changed in the head-end.

### BRIEF DESCRIPTION OF THE DRAWINGS

In the drawings:

FIG. 1 is a schematic diagram of a system for transmitting television signals from satellites to a home and for processing the television signals at the home to provide television images;

FIG. 2 is a schematic presentation of the MPEG2_{QPSK} bytes in a packet of QPSK television signals transmitted by a satellite transponder to an apartment building;

FIG. 3 is a schematic representation of the MPEG2_{QAM} bytes in a packet of QAM television signals transmitted through the cables within an apartment building;

FIG. 4 is a schematic representation of a frame or superpacket for converting MPEG2_{QPSK} packets of television signals to MPEG2_{QAM} packets of television signals,

FIG. 5 is a schematic indication of the binary bits in side bytes in the frame or superpacket shown in FIG. 4;

FIG. 6 is a schematic representation of successive 13-bit packets provided by a particular one of the binary bits in successive instances of the side bytes shown in FIG. 5;

FIG. 7a-7e schematically show progressive steps in converting MPEG2_{QPSK} packets of 130 signal bytes in a superpacket to MPEG2_{QAM} packets of 187 signal bytes; and

FIG. 8 is a schematic block diagram of one embodiment of an electrical system constituting this invention for converting packets of MPEG2_{QPSK} signal bytes from a satellite transponder to packets of MPEG2_{QAM} signal bytes and for providing for the processing of the MPEG2_{QAM} signal bytes to obtain television images in television receivers in an apartment building.

### DETAILED DESCRIPTION OF THE INVENTION

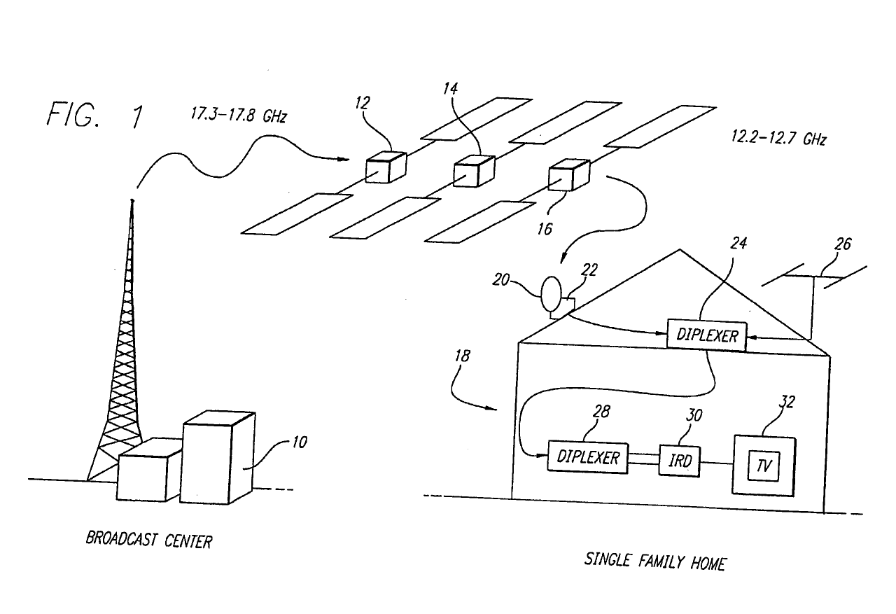

In one embodiment of the invention, a broadcast center 10 (FIG. 1) sends signals at a suitable gigahertz frequency such as in the range of approximately 17.3-17.8 gigahertz to satellites 12, 14 and 16 in the sky. The satellites 12, 14 and 16 retransmit these signals in the range of approximately 12.2-12.7 gigahertz. The satellite 12 supports sixteen (16) transponders which may transmit signal bytes at a relatively low rate such as approximately 23.58 megabits per second, using 24 MHz QPSK channels.

Each of the satellites 14 and 16 supports eight (8) transponders which operate at a high rate such as approximately 30.32 megabits per second, using 24 Megahertz QPSK channels. Each transponder in each of the satellites 12, 14 and 16 may carry five (5) or six (6) television channels. In this way, services such as Direct TV and USSB may offer approximately 175 channels of television signals. This is considerably in excess of the number of channels which are provided by analog terrestial transponders such as those involved in cable television.

The signals from the transponders 12, 14 and 16 may be received by a single family home such as that indicated generally at 18 in FIG. 1. The home 18 includes an antenna dish 20 which may be optimally positioned to simultaneously receive the aggregate of 32 transponders from the 3 satellites. The signals from the dish 20 pass to an LNB 22 which produces signals in the range of 950-1450 megahertz.

The signals from the LNB 22 then pass to a diplexer 24 which combines off air television signals from an antenna 26. The diplexer 24 is well known in the prior art. It allows signals at two (2) different frequency spectra (from the dish 20 and the antenna 26) to be combined at the diplexer 24 and split at the diplexer 28 to an integrated receiver/decoder 30. The signals from the integrated receiver/decoder 30 then pass to a television receiver 32 for the display of television images on the face of a monitor in the television receiver.

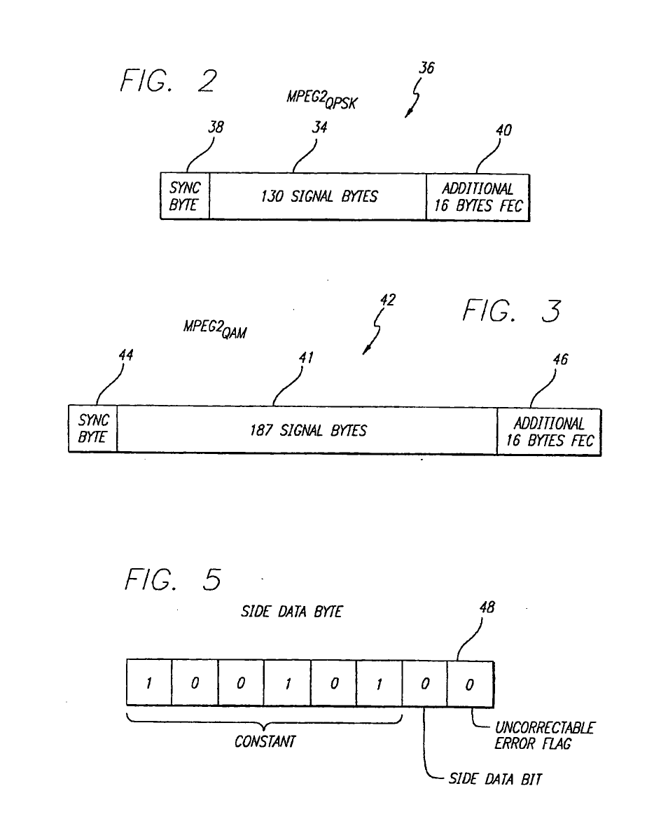

The QPSK signal bytes from the satellite transponders 12, 14 and 16 are transmitted as packets, which may be designated as MPEG2_{QPSK}. Each packet is formed from one hundred and thirty (130) signal bytes 34, each signal byte comprising eight (8) binary bits. This is generally indicated schematically at 36 in FIG. 2. The beginning of each packet 36 is defined by a sync byte 38 in FIG. 2. A forward error correction 40 is provided in each packet 36 and is indicated for each packet by sixteen (16) additional bytes at the end of such packet. The forward error correction 40 provides a certain amount of redundancy which allows the QPSK receiver to correct up to 8 errors within any packet 36. The forward error correction 40 is well known in the prior art.

The QAM signal bytes are also transmitted as packets, which may be designated as MPEG2_{QAM}. Each packet is formed from one hundred and eighty seven (187) signal bytes 41, each signal byte comprising eight (8) binary bits. This is generally indicated schematically at 42 in FIG. 3. The beginning of each packet 42 is defined by a sync byte 44 in FIG. 3. A forward error correction 46 of sixteen (16) bytes may be provided in each packet 42 at the end of such packet. The forward error correction 46 provides a certain amount of redundancy which allows the QAM receiver to correct up to 8 errors within any packet 42. The coding for the forward error correction 46 in the QAM signal packet is different from the coding for the forward error correction 40 in the QPSK signal packet 36. This is well known in the prior art.

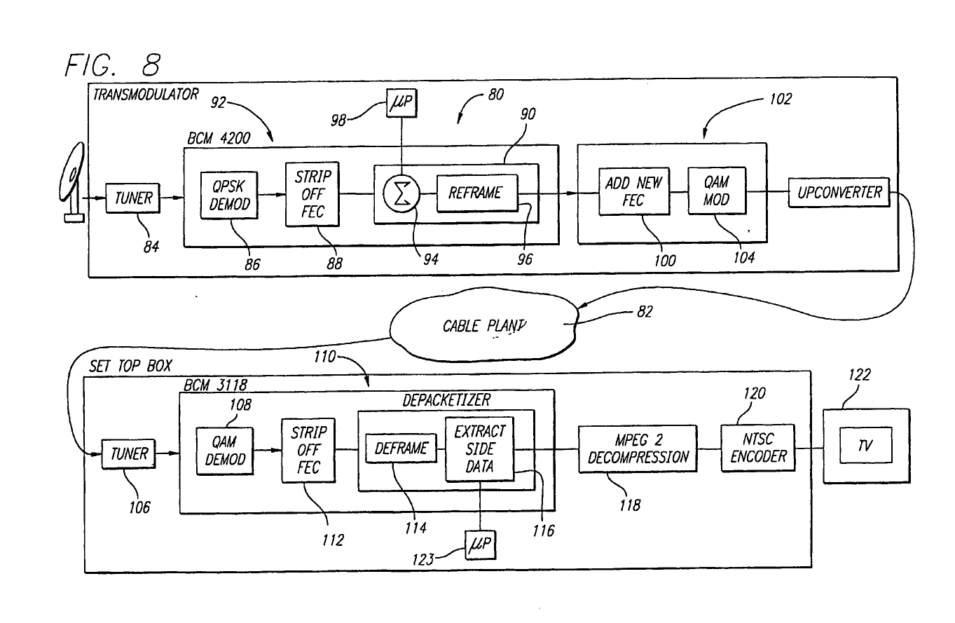

In a Multiple Dwelling Unit (MDU), it is desirable to convert from the MPEG2_{QPSK} packets shown in FIG. 2 to MPEG2 packets shown in FIG. 3 and to remodulate the QPSK signal into QAM prior to distribution through the MDU. This is done in the Transmodulator (FIG. 8). The signal is received via a settop box prior to display on a television receiver (FIG. 8).

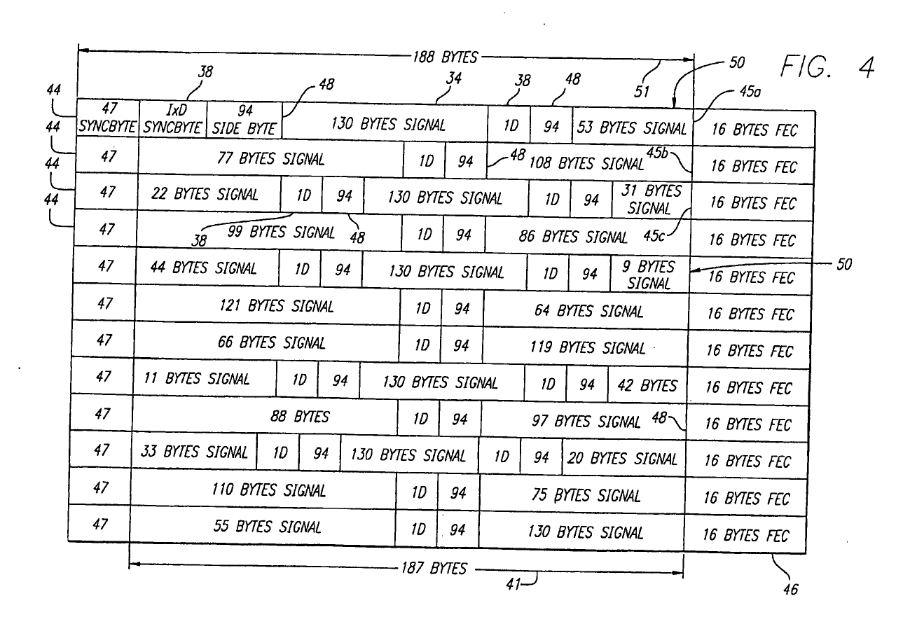

FIG. 4 indicates how the packets 36 of the QPSK signal bytes from the satellites 12, 14 and 16 are reframed to produce the packet 42 of the QAM signal bytes from the terrestial transponders. As will be seen, a plurality of horizontal lines 45 are provided in FIG. 4. Each horizontal line includes 187 signal bytes 41 corresponding to the number of the signal bytes in each of the packets 42 (FIG. 3). Each horizontal line 45 also includes one of the sync bytes 44 at the beginning of the line. Each horizontal line 45 also includes 16 additional bytes of FEC 46 at the end of the line. This causes 204 bytes to be included in each of the horizontal lines 45.

Since there only 130 signal bytes in each QPSK packet 36 (FIG. 2), each horizontal line 45 includes a full QPSK packet and a portion of one or more adjacent QPSK packets or includes portions of at least two (2) successive QPSK packets. For example, the first horizontal line 45a in FIG. 4 includes all of the 130 signal bytes (indicated by the numeral “130”) in the first QPSK packet 36 and includes the first fifty three (53) signal bytes (indicated by the numeral “53”) of the second QPSK packet 36. The first horizontal line 45a in FIG. 4 also includes the sync bytes 38 at the beginning of the first and second QPSK packets 36 (as indicated by the designation “1D”) and also includes a pair of side bytes 48 (as indicated by the numeral “94”) between the sync bytes 38 and the following QPSK packets 36. Thus, the sum of the number of sync bytes 38, the number of the side bytes 48 and the number of the signal bytes 41 in the first horizontal row 45a in FIG. 4 (not including the sync byte 44) is 187. This corresponds to the number of the signal bytes 41 in each of the QAM packets 42. Line 45a also includes 16 additional bytes of FEC 46 at the end of the line, creating a total of 204 bytes.

In like manner, the first byte in the second horizontal row 45b in FIG. 4 is a sync byte 44 for a QAM packet 42. This is followed in the horizontal row 45b by 77 signal bytes. These signal bytes constitute the difference between a QAM packet of 130 signal bytes and the 53 signal bytes near the end of the first horizontal row 45a. The 77 signal bytes in the second horizontal row 45b are followed by a sync byte 38, a side byte 48 and then by 108 bytes in a third one of the QPSK packets 36. Thus, the sum of the bytes in the second horizontal row (not counting the sync byte 44 at the beginning of the horizontal row 45a and not counting the additional 16 bytes FEC 46 at the end of horizontal row 45a) is 187.

There are 22 signal bytes following the sync byte 44 at the beginning of the third horizontal row 45c. This constitutes the difference between the 130 signal bytes in each QPSK packet 36 and the 108 signal bytes at the end of the second horizontal row 45b. These 22 signal bytes are followed in the third horizontal row 45c by a sync byte 38 and by a side byte 48. There are then 130 signal bytes constituting a complete QPSK packet 36 in the horizontal row 45c and this packet is followed by another sync byte 38 and another side byte 48. There are then 31 bytes at the end of the third horizontal row 45c. These constitute the first 31 bytes in the fourth (5th) QPSK packet 42. Thus, excluding the sync byte 44 at the beginning of the third horizontal row 45c, there are 22+1+1+130+1+1+31=187 bytes in the third horizontal row (excluding the additional 16 bytes FEC 46 at the end of the horizontal row 45c).

As will be seen in FIG. 4, there are 12 horizontal rows 45 in a frame or superpacket generally indicated at 50 in FIG. 4, each horizontal line containing 187 bytes (excluding the sync byte 44 at the beginning of such line and 16 bytes FEC 46 at the end of the line). This is a total of (187)*(12)=2244 bytes. As will be seen in FIG. 4, there are 17 QPSK packets each containing 130 signal bytes, for a total of 2210 bytes. There are also 17 sync bytes 38 and 17 side bytes 48 in the frame or superpacket 50. The resultant total in the frame 50 is 2244 bytes, the same as provided for the QAM packets 42. Of this total of 2244 bytes, 17 represent additional bytes provided by the side bytes 48. This represents an addition of 17/2244=approximately 0.76% in the number of bytes added to the frame 50. It accordingly represents an increase of only approximately 0.76% in the required bandwidth as a result of the inclusion of the 17 side bytes in each superpacket.

Each side byte 48 is shown in FIG. 5 and is formed from eight (8) binary bits. The first six (6) bits (from the left) in each side byte 48 provide a substantially constant and distinctive code to indicate that the byte constitutes a side byte. The 8^{th} bit in each side byte 48 indicates as by a binary 0 that there is no uncorrectable error (i.e. valid data) in the QPSK packet which follows such side byte. The 8^{th} bit in each side byte indicates by a binary 1 that there is an uncorrectable error in the QPSK packet which follows such side byte.

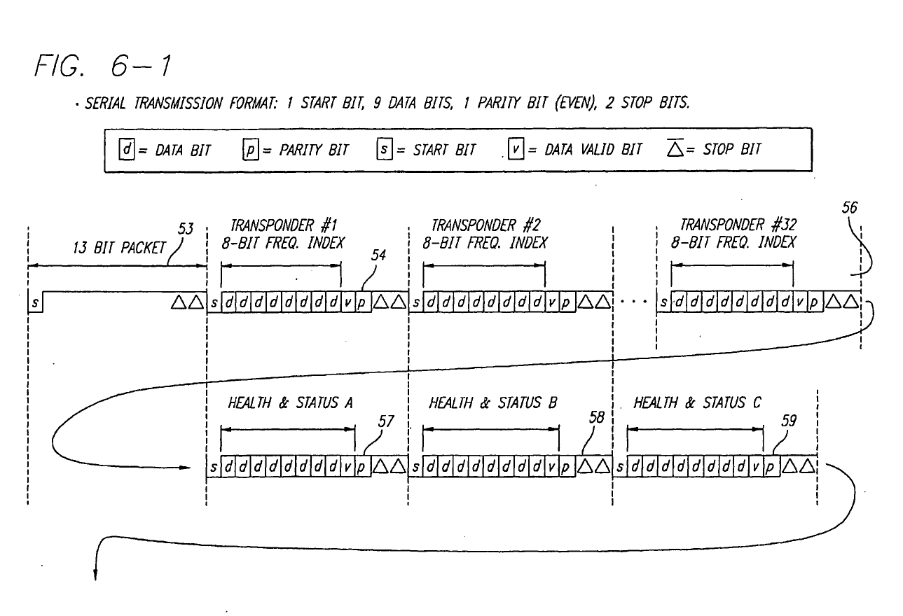

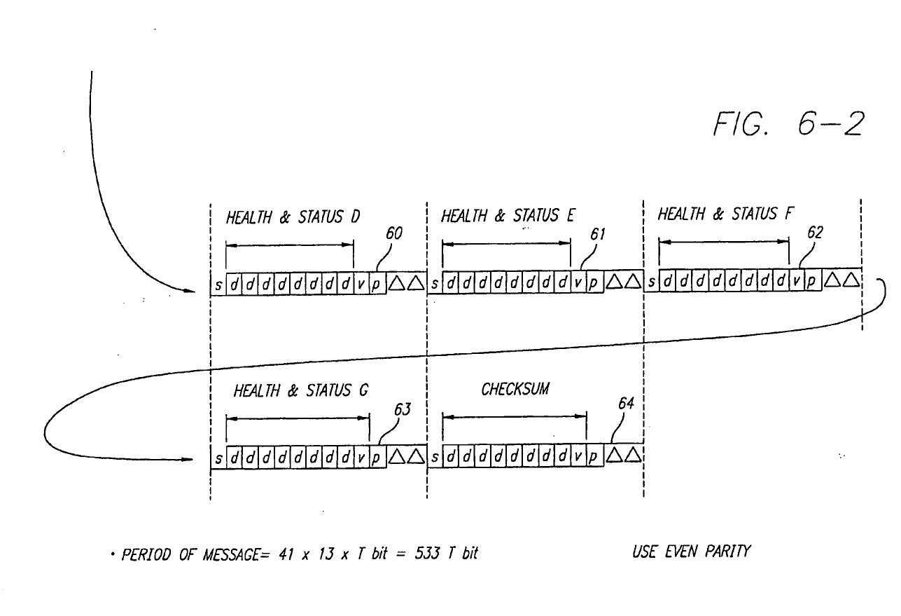

As previously indicated, there are seventeen (17) QPSK packets 36 in each frame or superpacket 50 (FIG. 4). Each of the packets 36 includes one of the side bytes 48. The seventh (7th) bits from successive instances of the side bytes 48 are organized as groups, each including thirteen (13) bits. These successive groups of thirteen (13) binary bits are shown in FIG. 6. They provide individual information. This is indicated in FIG. 6. The first instance 53 of such thirteen (13) bit packets provides an indication on a reserved basis of the start of the message indications in the successive instances of the successive thirteen (13) bit packages. This start packet 53 is indicated by a particular sequence of bit values in the successive instances of the thirteen (13) bits of that packet.

The previous discussion has indicated that there are a total of thirty two (32) transponders in the satellites 12, 14 and 16. The second instance 54 of the thirteen (13) bit packets (after the start packet 53) has a particular sequence. In this sequence, the first bit constitutes the start bit for the packet. The next eight (8) bits in the 13-bit packet 54 (indicated by the letter “d”) in the packet provide data individual to that packet. The tenth (10th) binary bit in the packet 54 indicates a data valid bit. This is indicated by the letter “v”. The eleventh (11th) binary bit in the packet 54 constitutes a parity bit as indicated by the letter “p”. The twelfth (12th) and thirteenth (13th) bits in the packet constitute stop bits as indicated at ΔΔ.

FIG. 6 indicates a sequence of the thirteen (13) bit packets. As previously discussed, the first such packet 53 in the sequence indicates the start of the sequence of packets. The second one 54 of such packets is indicated as “Transponder #1”. It indicates (in the 2^{nd} through 9^{th} bits) the particular frequency location in the cable plant that the television receivers in the apartments in the apartment building should tune to receive the transmodulated television signals from the first one of the thirty two (32) transponders in the satellites 12, 14 and 16.

In like manner, successive instances of such thirteen (13) bit packets indicate the frequency location in the cable plant that television receivers in the apartments in the apartment building should be tuned to receive the transmodulated television signals from successive channels of the thirty two (32) transponders in the apartment building. This may be seen from the designation of the second packet 54 in FIG. 6 as “Transponder #1” and from the designation in FIG. 6 of the thirty third (33rd) packet 56 in FIG. 4 as “Transponder #32”.

Successive instances 57 through 63 of the thirteen (13) bit packets after the packet 56 designated as “Transponder #32” are then provided. These 13-bit packets indicate other information than the particular frequency location of the television channel for the television signals from the different channels of the transponders in the satellites 12, 14 and 16. For example, the 13-bit groups 57-63, designated as “Health & Status A-G”, may indicate certain specified information such as the error messages, phone numbers for service, BER thresholds, transmodulator temperature, etc.

A last 13-bit group 64 the sequence may then be provided. This packet is designated as “Checksum”. This 13-bit group provides a parity check. It sums the values of the binary indications in each of the preceding groups in the sequence and is used at the receiver to determine if a bit error has occurred during transmission. A group providing a “Checksum” comparison is known in the prior art but not in the context of this invention. After a fixed period of “dead time” during which no data is sent, the cycle repeats starting with another 13-bit start packet 53.

Satellite television is only relatively recent, probably less that five (5) years before the date of filing of this patent application. Because of this, apartment buildings more than five (5) years old are able to receive and process only terrestial signals in the QAM or NTSC formats. As will be appreciated, most apartment buildings in the United States and throughout the world are more than five (5) years old. For example, cable plants are provided in these buildings to receive QAM or NTSC signals involved in terrestial television. These cable plants are provided to distribute the QAM and NTSC signals and introduce the television signals in the different channels in terrestial television to the individual apartments in the buildings in accordance with the selection of the different channels by the individual apartments. These cable plants do not have sufficient bandwidth to distribute the QPSK signals from the satellites 12, 14 and 16 through the apartment buildings and cannot introduce these signals to the individual apartments in the apartment building.

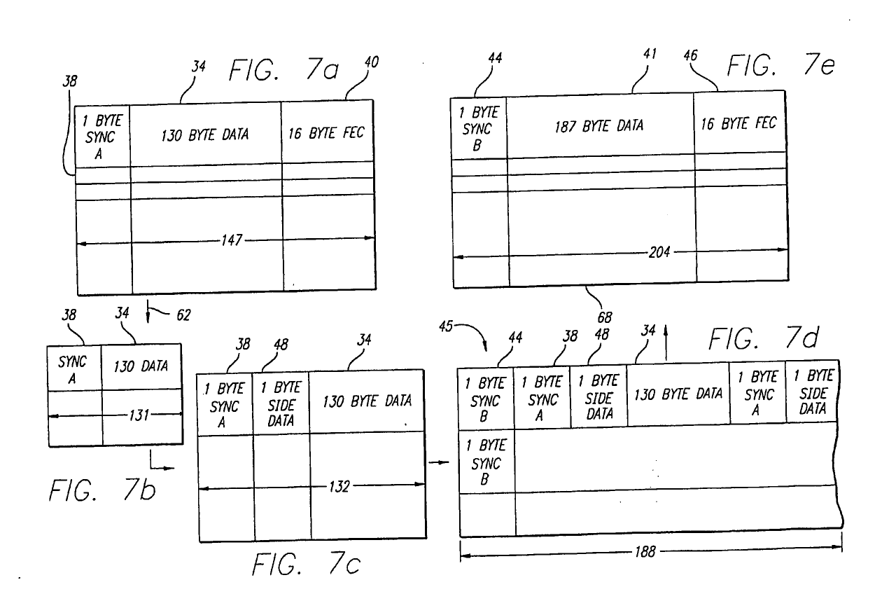

The provision of the superpackets 50 (FIG. 4) and the conversion of the MPEG2_{QPSK} packets in each superpacket to the MPEG2_{QAM} packets in each such superpacket converts MPEG2_{QPSK} to MPEG2_{QAM} to allow the use of standard QAM modulator chips to provide the conversion from QPSK to QAM. FIG. 7 schematically indicates the steps in converting the QPSK packets 36 in each superpacket 50 to the QAM packets 42 in such superpacket.

As will be seen in FIG. 4, each superpacket 50 is formed from a number of horizontal lines 45 each containing a quantity of sync bytes 38 indicated at 1D in FIG. 4, a quantity of side data bytes 48 indicated as 94, multiple portions of 130 QPSK signal bytes and 16 bytes constituting the forward error correction 46. This superpacket is created from the MPEG2_{QPSK} packet in FIG. 2. As a first step, the forward error correction 40 is stripped from the MPEG2_{QPSK} packet in each superpacket. This is indicated at 62 in the transition between FIGS. 7a and 7b. The resultant packets are illustrated in FIG. 7b. The side bytes 48 are then added to each of the MPEG2_{QPSK} packets immediately after the sync byte 38 for that packet and immediately before the 130 signal bytes 34 for that packet. This is indicated in FIG. 7c.

The next step in the schematic sequence shown in FIGS. 7a-7e is to reframe the MPEG2_{QPSK} packets of 130 signal bytes 34 in each superpacket to MPEG2_{QAM} packets of 187 signal bytes 44 in such superpacket and to add the sync byte 44 at the beginning of each of the horizontal lines 45. This is indicated in FIG. 7d.

Using the sync bytes 44 as the first byte in each horizontal line in the superpacket, the format in FIG. 7d can be represented so that the 187 signal bytes 41 for each packet follow the sync byte 44 for that packet. In the process of accomplishing this, the sync byte 38 for each of the MPEG2_{QAM} packets in such superpacket is treated as part of the 187 byte data, 41, and is no longer indicated. The MPEG2_{QAM} packets then have the format indicated in FIG. 7e.

As an additional step in reframing the MPEG2_{QPSK} packets to MPEG2_{QAM} packets, the forward error correction 46 of sixteen (16) bytes is added at the end of each MPEG2_{QAM} packet in the superpacket 50. This is indicated in FIG. 7e. The forward error correction 46 for each of the MPEG2_{QAM} packets has the same number of bytes as the forward error correction 40 for each of the MPEG2_{QPSK} packets but has a different format than the forward error correction for the MPEG2_{QPSK} packets.

FIG. 8 is a schematic block diagram of a system generally indicated at 80 for providing for the reception of QPSK television signals from the satellites 12, 14 and 16 in an apartment building having a cable plant 82 wired for the reception of QAM or NTSC television signals from terrestial transponders. The system 80 shown in FIG. 8 provides for the reception of QPSK signals from the satellites 12, 14, and 16, and the conversion of the QPSK signals to QAM signals prior to distribution through the apartment building. This conversion is called transmodulation and the system is called the transmodulator. This is indicated in FIG. 8.

The transmodulator system shown in FIG. 8 includes a tuner 84 for receiving the QPSK signals from the satellites 12,14 and 16 in the gigabyte range. The signals from the tuner 84 pass to a demodulator 86 which recovers the QPSK signals representing the television image. The sixteen (16) additional bytes 40 in the forward error correction are used and then stripped by a stage 88 from the packets of the MPEG2_{QPSK} signals bytes 34 as indicated in the transition between FIGS. 7a and 7b.

The QPSK demodulator 86, the forward error correction stripper 88 and a packetizer 90 are included in an integrated circuit chip shown as a rectangle generally indicated at 92. The integrated circuit chip 92 is designated as the BCM 4200 satellite receiver chip by applicants' assignee of record in this application. The packetizer 90 in the chip 92 includes a summer 94 and a stage designated as a reframer 96. The summer 94 adds the side bytes 48 (FIG. 4) to the MPEG2_{QPSK} packets 36 of 130 signal bytes 34 in each superpacket as shown in FIG. 7b. The reframer 96 reframes the MPEG2_{QPSK} packets in each superpacket to the MPEG2_{QAM} packets in each superpacket as shown in FIG. 7c and as discussed in detail above. The side data 48 (FIG. 4) are created and presented to the summer 94 in the packetizer 90 by a microprocessor 98 in FIG. 8.

After the MPEG2_{QPSK} packets 36 in each superpacket 50 have been reframed to MPEG2_{QAM} packets 42 in each superpacket, the reframed signals are introduced to a stage 100 in an integrated circuit chip designated by applicants' assignee as a BCM 3033 QAM modulator chip. The integrated circuit chip is indicated by a rectangular border generally indicated at 102 and enclosing the stage 100 and a QAM modulator 104. The stage 100 adds a new forward error correction for each of the MPEG2_{QAM} packets in the superpacket as indicated in the transition between FIG. 7d and FIG. 7e.

The QAM modulator 104 modulates the signal bytes in the MPEG2_{QAM} packets 42 in a format so that the signals will pass through the cable plant 82. The frequency modulated QAM signals from the QAM modulator 104 are then upconverted to a carrier frequency at which the QAM or NTSC signals from terrestial transponders normally pass through the cable plant 82.

The modulated carrier signals passing through the cable plant 82 are introduced to a tuner 106 which is constructed to pass the signals at the carrier frequency. The modulated carrier signals are then demodulated in a QAM demodulator 108. The QAM demodulator 108 is included in an integrated circuit chip indicated generally at 110 within a rectangle and designated by applicants' assignee as a BCM 3118.

A stage 112 is included in the chip 110 to use and strip the forward error correction 46 from the MPEG2_{QAM} packets 42 in each superpacket. The MPEG2_{QAM} packets 42 are then deframed as at 114 to recover the MPEG2_{QAM} packets. The data in the side bytes 48 are then extracted and processed by a stage 116 under the control of a microprocessor 123. When the side bytes 48 are processed, the frequency location in the cable plant that television receivers in the apartments in the apartment building should tune to receive the transmodulated television signals for each of the transponders in the satellites 12, 14 and 16 are determined. This is shown in FIG. 6 and described in detail above. Health and status information is also determined from the side bytes 48 as shown in FIG. 6 and described in detail above. A parity check is also provided by the side bytes 48 as shown in FIG. 6 and described in detail above.

The signals in the bytes transmitted from the satellites 12, 14 and 16 are in a standardized compressed format. For example, the signals in such bytes are compressed in an MPEG2 format before being transmitted through the satellites 12, 14 and 16. The signals compressed in the MPEG2 format are decompressed in a stage 118 which is well known in the art. The decompressed signals are then encoded in an NTSC encoder 120 (which is well known in the art) to provide signals for introduction to a television receiver 122. The image represented by the QPSK signal bytes from the satellite 12, 14 and 16 are then reproduced on the face of the monitor in the television receiver 120.

Although this invention has been disclosed and illustrated with reference to particular embodiments, the principles involved are susceptible for use in numerous other embodiments which will be apparent to persons of ordinary skill in the art. The invention, therefore, is limited only as indicated by the scope of the appended claims.

1. In combination for providing for the introduction of satellite television into apartments in an apartment building having a cable plant wired to distribute terrestial television from a cable head end system,
means at the apartment building for receiving signals providing the satellite television and having a first particular framing,
means at the apartment building for reframing the satellite television signals in the first particular framing to a second particular framing corresponding to that provided for terrestial television,
means at the apartment building for distributing the signals in the second particular framing through the cable plant, and
means at the apartments in the apartment building for operating upon the signals in the second particular framing, after the passage of such signals through the cable plant, to deframe the television signals prior to conversion to a television image.

2. In a combination as set forth in claim 1 wherein
the signals are modulated directly from the second particular framing for the terrestial television before the signals are passed through the cable plant and wherein
the signals modulated for terrestial television are demodulated after passage through the cable plant.

3. In a combination as set forth in claim 1 wherein
means are provided at the apartments in the apartment building for operating upon the signals in the second particular framing, after the deframing of such signals, to provide for the reproduction of the television image represented by such signals.

4. In a combination as set forth in claim 1 wherein
the signals received at the apartment building are in the form of packets defined by a first particular number of signal bytes in each packet and wherein the reframing means reframe the packets from the first particular framing to the second particular framing defined by a second particular number of signal bytes in each such packet and wherein means are provided at the apartment building for adding a side byte at a particular position in each packet in the first particular framing to provide information to the apartment house for processing the information in such packet.

5. In a combination as set forth in claim 2 wherein
means are provided at the apartments in the apartment building for operating upon the signals in the second particular framing, after the deframing of such signals, to provide for the reproduction of the television image and wherein
the signals received at the apartment building are in the form of packets defined by a first particular number of signal bytes in each packet and wherein the reframing means reframe the packets from the first particular framing to the second particular framing defined by a second particular number of signal bytes in each such packet and wherein means are provided at the apartment building for adding a side byte at a particular position in each packet in the first particular framing to provide information to the apartment house for processing the information in such packet.

6. In combination for providing for the introduction of satellite television from satellite transponders into television receivers in apartments in an apartment building having a cable plant wired to distribute terrestial television from a cable head end system,
means at the apartment building for receiving packets of signal bytes from the satellite transponders, each packet being defined by a first frame having a first particular number of signal bytes,
means at the apartment building for refraining the packets of signal bytes in the first frames to packets each defined by a second particular number of signal bytes in a second frame different from the first frame and corresponding to that provider from the terrestial transponders
means at the apartment building for distributing the signal bytes in the second frames through the cable plant, and
means at the apartment in the apartment building for deframing the packets of signal bytes in the second frames after the passage of the signal bytes in the second frames through the cable plant.

7. In combination as set forth in claim 6 wherein
the signal bytes in the packets in the second frames are modulated before such signal bytes are distributed through the cable plant and wherein
the signal bytes modulated in the packets in the second frames for terrestial navigation are demodulated after such modulated signal bytes are distributed through the cable plant.

8. In a combination as set forth in claim 6 wherein
at least one additional signal byte is provided at the apartment building with each of the packets of the signal bytes in the first frames to indicate the existence or lack of existence of a forward uncorrectable error in the packet and wherein
means are provided for reformatting the at least one additional signal byte at the apartment building in the first frames in accordance with the reframing of the packets from the first frames to the second frames and wherein
means are provided for processing the at least one additional signal byte, after the reframing of each packet in the second frame, to provide for the operation of the television receivers in the apartments in the apartment building in finding and reproducing the television image represented by the signal bytes from the satellite transponders, including error concealment if necessary.

9. In a combination as set forth in claim 6 wherein
at least one additional signal byte is provided at the apartment building with each of the packets of the signal bytes in the first frames to indicate particular information individual to such packets and wherein
means are provided at the apartment building for reforming the at least one additional signal byte at the apartment building in accordance with the reframing of the packets from the first frames to the second frames and wherein
means are provided at the apartment building for processing the particular information in the at least one additional byte after the reframing of the packets from the first frames to the second frames.

10. In a combination as set forth in claim 8 wherein
at least one additional signal byte is provided at the apartment building with each of the packets of the signal bytes in the first frames to indicate particular information individual to such packets and wherein
means are provided at the apartment building for reforming the at least one additional signal byte at the apartment building in accordance with the reframing of the packets from the first frames to the second frames and wherein
means are provided at the apartment building for continued processing of the particular information in the at least one additional byte after the reframing of the packets from the first frames to the second frames.

11. In combination for providing for the introduction of satellite television from satellite transponders into apartments in an apartment building having a cable plant wired to distribute terrestial television from a cable head end system,
means at the apartment building for receiving a plurality of first packets each defined by a first sync byte and by a first number of signal bytes individual to satellite television,
means at the apartment building for providing second sync bytes at positions in the first packets to define second packets each having a second number of signal bytes for terrestial television, the second number being different from the first number,
means at the apartment building for providing continued processing of the second packets of signal bytes in accordance with the positioning of the second sync bytes.

12. In combination as set forth in claim 11,
means at the apartment building for adding to each of the first packets a side byte at a particular position relative to the first sync byte for such packet to provide additional information to aid in the detection and processing of the signal bytes in the packets, and
means at the apartment in the apartment building for processing the signal bytes in the second packets in accordance with the additional information supplied in the side bytes for the detection and processing of the signal bytes in the packets, including error concealment if necessary.

13. In a combination as set forth in claim 11,
the receiving means at the apartment building also receiving for each of the first packets a first plurality of bytes including a forward error correction for each of the first packets,
means at the apartment building for reframing the first plurality of bytes into a second plurality of bytes and adding the forward error correction for the second packets,

14. In a combination as set forth in claim 11,
means at the apartment building for modulating the signal bytes in each of the second packets after the second sync bytes and a new forward error correction have been added,
a cable plant at the apartment building for distributing the modulated signal bytes in each of the second packets, and
means at the apartments in the apartment building for demodulating the modulated signal bytes in the second packets after the passage of the modulated signal bytes in the second packets through the cable plant.

15. In a combination as set forth in claim 12,
the receiving means at the apartment building also receiving a first plurality of bytes as well as a forward error correction for each of the first packets,
means at the apartment building for converting the first plurality of bytes into a second plurality of bytes and adding the forward error correction for the second packets,
means at the apartment building for modulating the signal bytes in each of the second packets after the second sync bytes have been added,
a cable plant at the apartment building for distributing the signal bytes in each of the second packets, and
means at the apartments in the apartment building for demodulating the modulated signal bytes in the second packets after the distribution of the modulated signal bytes in the second packets through the cable plant.

16. In combination for providing for the introduction of satellite television from satellite transponders into apartments in an apartment building having a cable plant wired to distribute terrestial television from a cable head end system,
means at the apartment building for receiving MPEG2_{QPSK} signals from the satellite transponders,
means at the apartment building for reframing the MPEG2_{QPSK} signals into MPEG2_{QAM} signals representing terrestial television from the terrestial transponders,
means at the apartment building for providing side signals providing information to aid in processing to be provided in the apartments in the apartment building on the QAM signals, and
means at the apartments in the apartment building for processing the QAM signals in accordance with the information provided by the side signals.

17. In a combination as set forth in claim 16 wherein
the receiving means receives signals including forward error correction bytes in the MPEG2_{QPSK} signals and wherein
means are provided at the apartment buildings, to perform forward error corrections in the MPEG2_{QPSK} signals, for creating an uncorrectable error flag and for creating new forward error correction bytes for the MPEG2_{QAM} signals and wherein
means are provided at the apartment building for performing forward error corrections at the apartments in the apartment building using the forward error correction bytes in the MPEG2_{QAM} signals.

18. In a combination as set forth in claim 16,
means at the apartment building for providing side signals having indications aiding in the detection and processing of the MPEG2_{QAM} signals received at the apartment buildings and
means at the apartment building for detecting and reproducing the MPEG2_{QAM} signals in accordance with the indications in the side signals.

19. In a combination as set forth in claim 16,
the MPEG2_{QPSK} signals being provided in packets of first signal lengths, the MPEG2_{QPSK} signals also including sync signals indicating the beginning of the packets of the first signal lengths,
the MPEG2_{QAM} signals being provided in packets of second signal lengths different from the first signal lengths,
means responsive at the apartment building for including, in each packet of the MPEG2_{QAM} signals, signals indicating the beginning of each MPEG2_{QPSK} packet,
means responsive to the sync signals for the MPEG2_{QPSK} packets, and to the relative lengths of the MPEG2_{QPSK} and MPEG2_{QAM} packets, for producing separate sync signals at the beginning of each of the MPEG2_{QAM} packets.

20. In a combination as set forth in claim 19 wherein
the receiving means receives signals including forward error correction bytes in the MPEG2_{QPSK} signals and wherein
means are provided at the apartment buildings, to perform forward error corrections in the MPEG2_{QPSK} signals, for creating an uncorrectable error flag and for creating new forward error correction bytes in the MPEG2_{QAM} signals and wherein
means are provided at the apartment building for performing forward error corrections at the apartments in the apartment building using forward error correction bytes in the MPEG2_{QAM} signals and wherein
means are provided at the apartment building for providing side signals having indications aiding in the detection and processing of the MPEG2_{QAM} signals received at the apartment buildings and wherein
means are provided at the apartment building for detecting and reproducing the MPEG2_{QAM} signals in accordance with the indications in the side signals.

21. In combination for providing for the introduction of satellite television into apartments in an apartment building having a cable plant wired to distribute terrestial television signals,
means at the apartment building for receiving MPEG2_{QPSK} packets of signal bytes, each MPEG2_{QPSK} packet including a first particular number of signal bytes and including a first sync byte at the beginning of each MPEG2_{QPSK} packet,
means at the apartment building for reframing the MPEG2_{QPSK} packets of signal bytes into MPEG2_{QAM} packets of signal bytes, each such QAM packet including a second particular number of signal bytes where the second particular number is different from the first particular number, and
means at the apartment building for providing a second sync byte at the beginning of each MPEG2_{QAM} packet of signal bytes.

22. In a combination as set forth in claim 21,
means at the apartment building for providing a plurality of superpackets each including a particular number of the MPEG2_{QPSK} packets of signal bytes and the first sync bytes for the MPEG2_{QPSK} packets of signal bytes in such superpacket and the second sync signals for the MPEG2_{QAM} packets of the signal bytes in such superpacket.

23. In a combination as set forth in claim 21,
means at the apartment building for providing a side byte for each of the MPEG2_{QPSK} packets of signal bytes, the side bytes aiding in detection and processing of the MPEG2_{QAM} signals,
means at the apartment building for separating the side bytes from the MPEG2_{QAM} packets of the signal bytes, and
means responsive at the apartment building to the side bytes for processing the MPEG2_{QAM} packets of signal bytes in accordance with the indications in the side bytes.

24. In a combination as set forth in claim 22,
means at the apartment building for providing a side byte at a particular position in each of the MPEG2_{QPSK} packets before the reframing of the MPEG2_{QPSK} packets into MPEG2_{QAM} packets,
the MPEG2_{QPSK} packets of signal bytes providing information for the production of television images,
each side byte providing information relating to the detection and processing of the signal bytes in the MPEG2_{QAM} packets to obtain television images, and
means at the apartment building for processing the information in the side bytes in the MPEG2_{QAM} packets, after the reframing of the MPEG2_{QPSK} packets into the MPEG2_{QAM} packets, to facilitate the distribution of the television images.

25. In a combination as set forth in claim 21,
the receiving means being operative to receive signal bytes including forward error correction bytes in the MPEG2_{QPSK} packets,
means for performing forward error correction in the MPEG2_{QPSK} packets, before the reframing of the signal bytes in the MPEG2_{QPSK} packets into the MPEG2_{QAM} packets of signal bytes, and
means for adding signal bytes representing new forward error correction in the MPEG2_{QAM} packets in a form compatible with the signal bytes in the MPEG2_{QAM} packets, such means being operative after the reframing of the MPEG2_{QPSK} packets of signal bytes into the MPEG2_{QAM} packets of signal bytes.

26. In a combination as set forth in claim 21,
the apartment building having a cable plant constructed to distribute the MPEG2_{QAM} packets of signal bytes,
means at the apartment building for modulating the MPEG2_{QAM} packets of signal bytes before the distribution of such packets through the cable plant,
means for distributing the MPEG2_{QAM} packets of the modulated signals through the cable plant, and
means for demodulating the MPEG2_{QAM} packets of the modulated signal bytes after the passage of such modulated signal bytes through the cable plant.

27. In a combination as set forth in claim 26,
the signal bytes in the MPEG2_{QPSK} packets received by the receiving means being compressed,
means for decompressing the MPEG2_{QPSK} signal bytes in the MPEG2_{QAM} packets after such signal bytes have been demodulated, and
means for operating upon the decompressed MPEG2_{QPSK} signal bytes in the MPEG2_{QAM} packets to recover the television images.

28. In a combination as set forth in claim 22,
means at the apartment building for providing a side byte at a particular position in each of the MPEG2_{QPSK} packets before the reframing of the MPEG2_{QPSK} packets of signal bytes into the MPEG2_{QAM} packets of signal bytes,
the signals bytes in the MPEG2_{QPSK} packets providing information for the production of television images each side byte in the MPEG2_{QAM} packets providing information relating to the detection and processing of the signal bytes in the MPEG2_{QAM} packets to obtain television images,
means at the apartment building for processing the information in the side bytes in the MPEG2_{QAM} packets, after the reframing of the MPEG2_{QPSK} packets into the MPEG2_{QAM} packets, to facilitate the distribution of the television images,
the receiving means being operative to receive the MPEG2_{QPSK} packets of signals bytes including forward error correction,
means for performing forward error correction in the MPEG2_{QPSK} packets before the reframing of the MPEG2_{QPSK} packets of signal bytes into the MPEG2_{QAM} packets of signal bytes, and
means for adding signal bytes representing new forward error correction in a form compatible with the signal bytes in the MPEG2_{QAM} packets, such means being operative after the reframing of the MPEG2_{QPSK} packets of signal bytes into the MPEG2_{QAM} packets of signal bytes,
the apartment building having a cable plant constructed to distribute the MPEG2_{QAM} packets of signal bytes,
means at the apartment building for modulating the MPEG2_{QAM} packets of signal bytes before the distribution of such packets through the cable plant,
means for distributing the MPEG2_{QAM} packets of modulated signal bytes through the cable plant,
means for demodulating the MPEG2_{QAM} packets of modulated signal bytes after the distribution of such MPEG2_{QAM} packets through the cable plant.
the signal bytes in the MPEG2_{QPSK} packets received by the receiving means being compressed,
means for decompressing the MPEG2_{QPSK} signal bytes in the MPEG2_{QAM} packets after such signal bytes have been demodulated, and
means for operating upon the decompressed MPEG2_{QPSK} signal bytes in the MPEG2_{QAM} packets to recover the television images.

29. In combination for providing for the introduction of satellite television from satellite transponders into apartments in an apartment building having a cable plant wired to distribute terrestial television from a cable head end system,
means at the apartment building for receiving MPEG2_{QPSK} packets of signal bytes, each packet including a first particular number of signal bytes and including a first sync byte at the beginning of the signal bytes forming each MPEG2_{QPSK} superpacket,
a second particular number of the MPEG2_{QPSK} packets defining a superpacket,
means at the apartment building for reframing the MPEG2_{QPSK} packets of signal bytes in each superpacket into MPEG2_{QAM} packets of signal bytes in such superpacket, each such MPEG2_{QAM} packet including a third particular number of signal bytes where the third particular number is different form the first particular number,
means at the apartment building for providing a second sync byte at the beginning of each MPEG2_{QAM} packet of signal bytes in each superpacket,
means responsive at the apartments in the apartment building to the sync byte in the MPEG2_{QAM} packets of signal bytes for processing the signal bytes in such MPEG2_{QAM} packets to recover the television images represented by such signal bytes.

30. In a combination as set forth in claim 29,
the apartments in the apartment building having television receivers,
means at the apartment building for providing a side byte in each MPEG2_{QAM} packet of signal bytes in each superpacket, the side bytes in the MPEG2_{QAM} packets having bits cumulatively indicating individual processing to be provided for the received television signals, and
means responsive to the cumulative indications of the particular bits in the side bytes in the MPEG2_{QAM} packets for providing the individual processing cumulatively indicated by such bits.

31. In a combination as set forth in claim 29,
means at the apartment building for using, in each of the MPEG2_{QPSK} packets of signal bytes in each superpacket, signal bytes indicating a forward error correction, and
means at the apartment building for substituting, for the signal bytes indicating the forward error correction for each of the MPEG2_{QPSK} packets of signal bytes, signal bytes indicating such forward error correction for each of the MPEG2_{QAM} packets of signal bytes in such superpacket.

32. In a combination as set forth in claim 31,
means at the apartment building for providing corrections in the television receivers in the apartments in the apartment building in accordance with the forward error corrections indicated by the signal bytes for each of the MPEG2_{QAM} packets in each superpacket.

33. In a combination as set forth in claim 30,
each of the side bytes in each MPEG2_{QAM} packet of signal bytes including a bit indicating the occurrence or lack of occurrence of an uncorrectable error in such packet,
each MPEG2_{QPSK} packet of signal bytes in each superpacket including additional bytes indicating uncorrectable errors, and
means for embedding the uncorrectable error indicated in each MPEG2_{QPSK} packet of signal bytes in each superpacket with signal bytes in each MPEG2_{QAM} packet.

34. In a method of providing for the introduction of satellite television from satellite transponders into apartments in an apartment building having a cable plant to distribute terrestial television from a head end system,
receiving at the apartment building packets of MPEG2_{QPSK} signal bytes where each packet includes a first particular number of MPEG2_{QPSK} signal bytes and includes a first sync byte defining the beginning of such packet and where a second particular number of the packets defines a superpacket and where the MPEG2_{QPSK} signal bytes provide the satellite television,
providing a second sync byte at the beginning of each packet of MPEG2_{QAM} signal bytes in each superpacket where the QAM signal bytes provide the terrestial television and where each packet of the MPEG2_{QAM} signal bytes includes a third particular number of signal bytes and where the third particular number is different form the first particular number, and
using the second sync bytes in the MPEG2_{QAM} packets in each superpacket to provide a processing of the MPEG2_{QAM} packets of signal bytes in each superpacket.

35. In a method as set forth in claim 34, the steps of:
providing at a particular position in each MPEG2_{QPSK} packet of signal bytes in each superpacket a side byte providing information controlling the detection and processing of the signal bytes in such MPEG2_{QAM} packet in such superpacket, and
processing each MPEG2_{QAM} packet of signal bytes in each superpacket in accordance with the information controlling in the side bytes the processing of the signal bytes in such MPEG2_{QAM} packet.

36. In a method as set forth in claim 34, the steps of:
providing, at a particular position in each of the MPEG2_{QPSK} packets of signal bytes in each superpacket, a side byte providing indications of the existence or lack of existence of uncorrectable errors in such MPEG2_{QPSK} packet,
processing the MPEG2_{QPSK} packets of signal bytes in each superpacket in accordance with the indication in the side bytes of such MPEG2_{QPSK} packets of the existence or lack of existence of the uncorrectable errors in such MPEG2_{QPSK} packets and in accordance with the additional signal bytes indicating the uncorrectable errors in such MPEG2_{QPSK} packets.

37. In a method as set forth in claim 34,
providing, at a particular position in each MPEG2_{QPSK} packet of signal bytes in each superpacket, a side byte providing at a particular bit in such side byte information cumulatively controlling, with the information at the particular bit in other MPEG2_{QPSK} packets in such superpacket, the processing of the signal bytes in the MPEG2_{QAM} packets in such superpacket, and
processing the MPEG2_{QAM} packets of signal bytes in each superpacket in accordance with the information cumulatively controlling, in the side bytes in such packets in such superpacket, the processing of the signal bytes in the MPEG2_{QAM} packets in such superpacket.

38. In a method as set forth in claim 35,
providing, at a particular position in each of the MPEG2_{QPSK} packets of signal bytes in each superpacket, a side byte providing indications of the existence or lack of existence of uncorrectable errors in such MPEG2_{QPSK} packets,
providing, in each MPEG2_{QPSK} packet of signal bytes in each superpacket, additional signal bytes indicating the uncorrectable errors in such MPEG2_{QPSK} packets, and
processing the MPEG2_{QPSK} packets of signal bytes in each superpacket in accordance with the indication in the side bytes of the existence or lack of existence of the uncorrectable errors in such MPEG2_{QPSK} packets and in accordance with the additional signal bytes indicating the uncorrectable errors in such MPEG2_{QPSK} packets,
providing at a particular binary bit in each side byte information cumulatively controlling, with the information at the particular binary bit in other side bytes in such superpacket, the processing of the signal bytes in such packets in such superpacket, and
processing the MPEG2_{QAM} packets of signal bytes in each superpacket in accordance with the information cumulatively controlling, in the side bytes in the MPEG2_{QPSK} packets in such superpacket, the processing of the signal bytes in the MPEG2_{QAM} packets in such superpacket.

39. In a method of providing for the introduction of satellite television from satellite transponders into apartments in an apartment building having a cable plant wired to distribute terrestial television from a head end system, the steps of:
providing at the apartment building signal bytes in MPEG2_{QPSK} packets each defined by a first particular number of signal bytes,
providing a plurality of the MPEG2_{QPSK} packets of signal bytes in a superpacket,
reframing the signal bytes in the superpacket into MPEG2_{QAM} packets of signal bytes where each MPEG2_{QAM} packet is defined by a second particular number of signal bytes different form the first particular number of signal bytes, and
processing the MPEG2_{QAM} signal bytes in the packets in the superpacket to form television images.

40. In a method as set forth in claim 39, the steps of:
the signal bytes in the MPEG2_{QAM} packets in the superpacket being compressed,
deframing the reframed MPEG2_{QPSK} packets of signal bytes, and
decompressing the deframed MPEG2_{QPSK} packets of signal bytes in the superpacket.

41. In a method as set forth in claim 39, the steps of:
modulating the signal bytes in the MPEG2_{QAM} packets in each superpacket,
distributing the modulated signal byes using QAM through the cable plant, and
demodulating the modulated QAM signal after passage of such modulated signal bytes through the cable plant.

42. In a method as set forth in claim 39, the steps of:
detecting sync bytes at the beginning of each of the MPEG2_{QPSK} packets of signal bytes in each superpacket,
forming sync bytes at the beginning of each of the MPEG2_{QAM} packets of signal bytes in each superpacket, and
reframing the signal bytes in the MPEG2_{QAM} packets of signal bytes in each superpacket in accordance with the sync bytes at the beginning of each of the MPEG2_{QAM} packets of signal bytes in each superpacket.

43. In a method of providing a television image on the face of a monitor in a television receiver, the steps of:
receiving a plurality of packets each including a plurality of signal bytes representing images to be displayed on the face of the television receiver,
providing in each of the received packets a sync byte indicating a first one of the packets in the plurality,
providing a side byte at each of the packets in the plurality, each of the side bytes being formed from a plurality of bits,
providing, at a particular position in each of the side bytes, a bit cumulatively indicating with corresponding bits in a sequence of the side bytes in successive instances of the packets, an individual selection of a plurality of television channels in the television receiver to receive the signal bytes, and
processing the signal bytes in the packets to provide the television image in the individual selection of the channels in the monitor in the television receiver.

44. In a method as set forth in claim 43, the steps of:
each of the received packets constituting first packets and being defined by a first number of signal bytes,
reframing the first packets to form second packets each defined by a second number of signal bytes,
distributing the second packets through a cable plant, and
deframing the second packets, after the passage of the second packets through the cable plant, to for the first packets for the processing of the first packets to provide the television image in the individual selection of the channels in the monitor in the television receiver.

45. In a method as set forth in claim 43, the step of:
the sequence of the signal bytes constituting a first sequence providing, at the particular position in the side bytes, bits cumulatively indicating, for a second sequence of the side bytes, the health and status of the head end system,
processing the bits in the side bytes in the second sequence to indicate the health and status of the head end system.

46. In a method as set forth in claim 43, the step of:
the particular position in each of the side bytes constituting a first particular position,
providing, at a second particular position in each of the side bytes, an indication of whether any error in the packet following such side byte is an uncorrectable error,
providing for each of the packets a plurality of bytes used for forward error correction, and
processing the bytes indicating the forward error correction for each packet in accordance with the value of the bits at the second particular position in the side bytes for each packet.
